(19) United States
(12) Patent Application Publication
(10) Pub. No.: US 2010/0227488 A1
(43) Pub. Date: Sep. 9, 2010

(54) Non-electric plug

(76) Inventor: Brian K. Lau, Orange, CA (US)

Correspondence Address: Morland C. Fischer, Suite 1300, 2030 Main Street, Irvine, CA, 92614, US

(21) Appl. No.: 12/380,925

(22) Filed: Mar. 6, 2009

(51) Int. Cl. H01R 13/443

(52) U.S. Cl. 439/148

(57) ABSTRACT

A non-electric plug to be removably located in the output jack of a portable, hand-held electronic device to prevent moisture, dust, and other foreign matter from entering the jack when an electrical connector has been detached from the jack. According to a preferred embodiment, the electronic device is a mobile cellular telephone (e.g., that known commercially as an iPhone) and the output jack thereof is a headphone jack. The plug includes a cylindrical body and a relatively narrow pointed tip to be received inwardly of the output jack. A relatively wide blocking head extends across the plug body so as to lie flush against and in direct contact with the exterior of the electronic device. A handle stands outwardly from the blocking head to be grasped by the fingers of a user at which to receive a pushing or pulling force to be applied to the plug body. One end of the flexible attachment is tied to the plug at the handle so that the electronic device can be carried and suspended from the attachment.

### BACKGROUND OF THE INVENTION

1. Field of the Invention

This invention relates to a removable, non-electric plug to be located in the output jack of a portable, hand-held electronic device (such as, for example, a mobile cellular telephone) to prevent moisture, dust and other foreign matter from entering the jack when the electronic device is not in use and/or after an electrical connector has been detached from the jack.

2. Background Art

Portable cellular telephones are commonly used by all segments of the population throughout the world. For many users, a cell phone has entirely replaced the traditional landline-based telephone. Conventional cell phones are now capable of performing a variety of (e.g., data, audio and video) applications in addition to person-to-person communications.

Cell telephones are typically provided with an output (i.e., headphone) jack to removably receive an electrical connector that communicates with a headphone or earpiece having a shape to fit in and/or around the ear of a user. In this manner, audio content can be delivered from the cell phone directly to the ear of the user. When the cell phone is not being used or at those times when an earpiece is not required, the electrical connector is usually detached from the output jack. Consequently, the jack is exposed to rain water, moisture, dust, dirt and other debris from the environment within which the cell phone is carried or stored. An accumulation of such foreign matter within the output jack can prevent reliable communication between the electrical connector after it is returned to the jack and the cell phone so as to negatively affect the transmission of audio content to the user. In extreme cases, the overall operation of the cell phone may be adversely impacted by the presence of foreign matter in the jack which may necessitate that the phone be repaired.

Accordingly, what would be desirable is the availability of a low-cost, non-electric plug that is removably received by the output jack of a portable electronic device (e.g., a mobile cellular telephone) to prevent foreign matter from entering the jack when the electronic device is not in use or at those times when an electrical connector has been detached from the jack.

### SUMMARY OF THE INVENTION

A non-electric plug to be removably received by the output jack of an electronic device to prevent moisture, dust and other foreign matter from entering the jack when the electronic device is not being used and/or at those times when an electrical connector has been detached from the jack of the device. The plug of this invention has particular application in cases where the electronic device is a mobile cellular telephone and an electrical connector is mated to the headphone jack thereof, whereby audio content is supplied from the phone to a headphone or earpiece which lies in communication with the electrical connector.

The plug includes a cylindrical body having a relatively narrow entry tip at the front end thereof and a relatively wide blocking head at the opposite end. In the assembled configuration, the entry tip and the body of the plug are received inwardly of the output jack, and the blocking head lies flush against and in direct contact with the exterior of the electronic device. Standing outwardly from the head of the plug is an (e.g., arcuate) handle, such that a gap is established between the handle and the head. The user can hold the handle in his fingers to apply a pushing or pulling force to the plug depending upon whether the plug is being attached to or removed from the output jack of the electronic device. One end of the flexible attachment (e.g., a cord, string or lanyard) can be tied to the plug through the gap and around the handle. The opposite end of the attachment is coupled to a grip, a key, a charm or the like. With the plug attached to the electronic device at its output jack, the electronic device can be carried by and suspended from the attachment.

### BRIEF DESCRIPTION OF THE DRAWINGS

FIG. 1 illustrates a non-electric plug removably received within an output jack of a portable, hand-held electronic device (e.g., a mobile cellular telephone) to prevent foreign matter from entering the jack;

FIG. 2 is a perspective view of the plug of FIG. 1 according to a preferred embodiment of the present invention;

FIG. 3 is a side view of the plug shown in FIG. 2;

FIG. 4 shows a handle attached to the plug;

FIG. 5 shows a key attached to the plug; and

FIG. 6 shows a charm attached to the plug.

### DESCRIPTION OF THE PREFERRED EMBODIMENT

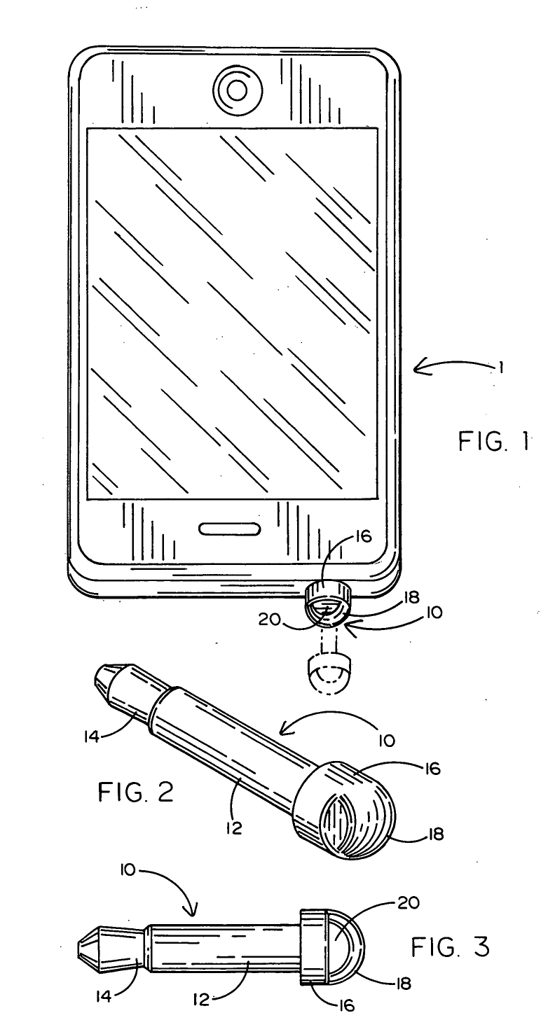

Turning to the drawings, there is shown in FIG. 1 a portable, hand-held electronic device 1 of the kind having an output jack (not shown) that is adapted to removably receive therewithin an electrical connector (also not shown). By way of particular example, the hand-held electronic device shown in FIG. 1 is a mobile cellular telephone having a headphone jack such as that commercially known as an iPhone. However, it is to be expressly understood that the advantages of the soon-to-be-described invention are also applicable to other portable electronic devices having an output jack in which to receive an electrical connector so as to facilitate the transmission of audio, video, analog, digital and other signals and information to a remote location.

There are many instances when the electrical connector is removed from the output jack of the electronic device. In these instances, the jack is susceptible to accumulating solid and/or liquid foreign matter from the environment in which the electronic device is used or stored. In the example where the electronic device 1 is a cell phone, the accumulation of foreign matter in the headphone jack can affect the transmission of audio content from the phone to the user. To avoid the entry of such foreign matter, a non-electric plug 10 is removably located within the output jack of the electronic device 1.

Details of the non-electric plug 10 are described while referring to FIGS. 2 and 3 of the drawings. Although it is preferably manufactured from plastic, the particular material used to manufacture the plug 10 is not to be considered a limitation of this invention. In accordance with a preferred embodiment, the plug 10 includes a cylindrical body or shank 12 having a diameter so as to be slidably received through and form a friction fit within the outputput jack of the electronic device 1. A generally narrow, pointed entry tip 14 is located at the front end of the plug body 12, and a relatively wide, disk-like blocking head 16 extends across the opposite rear end thereof. In the assembled configuration of FIG. 1, the body 12 and entry tip 14 of the plug 10 are received inwardly of the output jack, and the wide blocking head 16 of plug 10 lies flush against and in direct contact with the exterior of the electronic device 1.

Standing outwardly from the head 16 at the rear of plug 10 is a handle 18. The handle 18 is shown having an arcuate shape, although different handle shapes are within the scope of this invention. Located between the blocking head 16 and the handle 18 of plug 10 is an evacuated area or gap 20. The handle 18 and the gap 20 established therebelow cooperate to provide a variety of advantages. By way of a first advantage, the user can grip the handle 18 with his fingers so as to apply a pushing or pulling force to the plug 10, whereby the plug 10 is moved into receipt by or separated from the output jack of the electronic device.

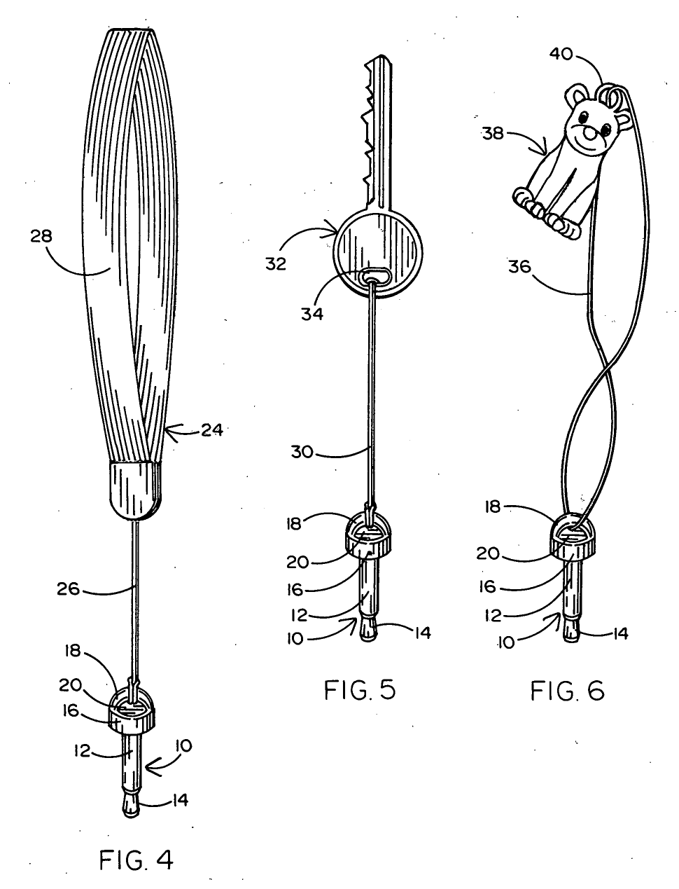

Other advantages of the handle 18 and gap 20 at the rear of the body 12 of plug 10 are illustrated in FIGS. 4-6 of the drawings. FIG. 4 shows a grip 24 connected to the plug 10 by means of a flexible attachment 26, such as a cord, a string, a lanyard, or the like, one end of which is secured to the grip 24. The grip 24 is preferably manufactured from a fabric or plastic material and includes a closed loop end 28 to be held in the hand of the user. Optional advertising can be printed on the grip 24.

The opposite end of the attachment 26 is tied to the plug 10 through the gap 20 and around the handle 18. With the plug 10 attached to the output jack of the electronic device 1 as shown in FIG. 1 and the user holding the looped end 28 of grip 24, the device 1 can be carried at the grip 24 and suspended from the attachment 26. Moreover, the plug 10 will not be easily separated from the grip 24 to reduce the chance that the plug will be lost.

In FIG. 5, a flexible attachment 30 like that described above when referring to FIG. 4 is shown extending between a key 32 and the plug 10. The attachment 30 is looped through the usual hole 34 in the key 32 and tied to the plug 10 through the gap 20 and around the handle 18. With the plug 10 attached to the output jack of the electronic device 1 as shown in FIG. 1 and the user holding the key 32, the device 1 can be carried at the key 32 and suspended from the attachment 30. Moreover, the plug 10 will not be easily separated from the key 32 to reduce the chance that the plug will be lost. In this same regard, the key 32 can be combined with a set of keys (not shown) coupled to a key ring that is received through the key hole 34.

In FIG. 6, a flexible attachment 36 like that described above is shown extending between a piece of jewelry, such as a charm 38 or a similar keepsake and the plug 10. The attachment 36 is looped through the usual coupling ring 40 affixed to the charm 38 and tied to the plug 10 through the gap 20 and around the handle 18. With the plug 10 attached to the output jack of the electronic device 1 as shown in FIG. 1 and the user holding the charm 38, the device 1 can be carried at the charm 38 and suspended from the attachment 36.

The non-electric plug 10 of this invention is inexpensive to manufacture and of small size so as to be conveniently carried in a user's pocket, purse, travel case, etc. When it is attached to one of the grip 24, key 32 or charm 38 of FIGS. 4-6, the plug 10 can be easily located for installation within the output jack of the electronic device 1 in order to advantageously block the entry of foreign matter to the jack.

1. A non-electric plug comprising a body having a first width and a blocking head extending across said plug body and having a second width which is larger than the first width of said plug body, and a handle standing outwardly from said blocking head such that a gap is established between said blocking head and said plug body, said handle receiving a pushing or pulling force to be applied to said plug body.

2. The plug recited in claim 1, further comprising a flexible attachment tied to said plug through said gap and around said handle such that said plug is carried at and suspended from said attachment.

3. A combination comprising:
an electronic device having a jack at which to receive an electrical connector; and
a non-electric plug to be located within the jack of said electronic device when the electrical connector is removed therefrom, said plug having a plug body received inwardly of the jack and a blocking head extending across said plug body and lying flush against and in direct contact with the exterior of said electronic device.

4. The combination recited in claim 3, wherein said electronic device is a mobile cellular telephone and the jack thereof is a headphone jack.

5. The combination recited in claim 3, wherein said plug also has a handle standing upwardly from said blocking head to receive a pushing or pulling force to be applied to said plug body, and a gap established between the blocking head and the body of said plug.

6. The combination recited in claim 5, further comprising a flexible attachment tied to said plug through said gap and around said handle, such that said electronic device is suspended from said attachment when said plug is located within the jack of said electronic device.

7. The combination recited in claim 6, further comprising a grip having a shape adapted to be held in the hand of a user, one end of said attachment tied to said plug and the opposite end of said attachment secured to said grip.

8. The combination recited in claim 7, wherein said grip is a closed loop.

9. The combination recited in claim 7, wherein said grip is a key.

10. The combination recited in claim 6, wherein said grip is a piece of jewelry.
